(19) United States
(12) Patent Application Publication
(10) Pub. No.: US 2018/0301255 A1
(43) Pub. Date: Oct. 18, 2018

(54) COMPOSITE MAGNETIC MATERIAL AND MOTOR

(71) Applicant: CANON KABUSHIKI KAISHA, Tokyo (JP)

(72) Inventors: Daisuke Sasaguri, Yokohama-shi (JP); Naoki Nishimura, Tokyo (JP); Tatsuo Kishikawa, Yokohama-shi (JP)

(21) Appl. No.: 15/946,583

(22) Filed: Apr. 5, 2018

(30) Foreign Application Priority Data
Apr. 12, 2017 (JP) 2017-079190
Feb. 13, 2018 (JP) 2018-023553

(51) Int. Cl. H01F 1/03; H02K 1/02; C22C 29/12

(52) U.S. Cl. CPC H01F 1/0315; C22C 29/12; H02K 1/02

(57) ABSTRACT

A composite magnetic material includes a soft magnetic material and a hard magnetic material. The soft magnetic material and the hard magnetic material each contain elemental iron, 90 atom % or more and 100 atom % or less of the elemental iron contained in the soft magnetic material forms a first oxide or a first composite oxide, and 90 atom % or more and 100 atom % or less of the elemental iron contained in the hard magnetic material forms a second oxide or a second composite oxide.

### BACKGROUND OF INVENTION

### Field of Invention

The present disclosure relates to a composite magnetic material and a motor.

### Background Art

Neodymium magnets (composition: Nd₂Fe₁₄B, for example) are known as a high-performance magnet. Neodymium magnets are widely used because they have a high residual magnetic flux density and a high coercive force.

Neodymium magnets contain neodymium, which is a rare-earth element, as an essential component. There has been a demand to reduce the amount of rare-earth elements used because of the high cost and concern for irregular supply of rare-earth elements. Thus, there has been an attempt to produce a high-performance magnet with a decrease in the amount of rare-earth elements used.

Japanese Patent Laid-Open No. 2011-35006 (hereinafter, Patent Literature 1) describes a core-shell magnetic material including a core that is a hard magnetic phase including epsilon-iron oxide (ε-Fe₂O₃) and a shell that is a soft magnetic phase including alpha iron (α-Fe) and covers at least a part of the core. In Patent Literature 1, ε-Fe₂O₃ as a hard magnetic phase with a high coercive force and α-Fe as a soft magnetic phase with a high saturated magnetic flux density are provided, and a nano-composite magnet in which both components are magnetically coupled to each other by the exchange coupling interaction is produced.

### SUMMARY OF INVENTION

The present disclosure provides a composite magnetic material including a soft magnetic material and a hard magnetic material. The soft magnetic material and the hard magnetic material each contain elemental iron, 90 atom % or more and 100 atom % or less of elemental iron contained in the soft magnetic material forms a first oxide or a first composite oxide, and 90 atom % or more and 100 atom % or less of elemental iron contained in the hard magnetic material forms a second oxide or a second composite oxide.

Further features will become apparent from the following description of exemplary embodiments with reference to the attached drawings.

### BRIEF DESCRIPTION OF DRAWINGS

FIGS. 1A and 1B are schematic illustrations of a structure of a composite magnetic material according to a first embodiment.

FIG. 2 is a schematic illustration of a structure of a composite magnetic material according to a second embodiment.

### DESCRIPTION OF EMBODIMENTS

In a magnetic material including an iron-based material containing elemental iron, the iron-based material is sometimes exposed on the surface of the magnetic material. This occurs particularly frequently when the iron-based material is used as a shell of a core-shell magnetic material as described in Patent Literature 1.

When iron or a ferrous alloy is used as the iron-based material, the iron and the ferrous alloy are likely to be oxidized by air and moisture. Thus, when iron or a ferrous alloy included in a magnetic material is exposed on the surface of the magnetic material, the iron and the ferrous alloy are oxidized by air and moisture, thereby deteriorating the magnetic properties of the magnetic material. In other words, there has been an issue in which a composite magnetic material containing elemental iron has low temporal stability.

In view of the foregoing, the present disclosure provides a composite magnetic material containing elemental iron and having high temporal stability.

Hereinafter, the embodiments of the present disclosure will be described. The present disclosure is not limited to the following embodiments, and modifications and improvements of the following embodiments made by a person skilled in the art in accordance with general knowledge are included in the scope of the present disclosure.

### First Embodiment

The composite magnetic material according to the present embodiment is a composite magnetic material including a soft magnetic material and a hard magnetic material. The soft magnetic material and the hard magnetic material each contain elemental iron. Furthermore, 90 atom % or more and 100 atom % or less of the elemental iron contained in the soft magnetic material forms a first oxide or a first composite oxide, and 90 atom % or more and 100 atom % or less of the elemental iron contained in the hard magnetic material forms a second oxide or a second composite oxide.

In this specification, the “soft magnetic material” refers to a material with a low coercive force and a high saturated magnetic flux density. In this specification, the “hard magnetic material” refers to a material with a high coercive force.

The composite magnetic material according to the present embodiment has a fine mixed structure in which two phases such as the phase of the soft magnetic material (soft magnetic phase) and the phase of the hard magnetic material (hard magnetic phase) are adjacent to each other at a distance on the order of nanometers. Due to such a fine mixed structure, an exchange coupling interaction occurs between the soft magnetic phase and the hard magnetic phase. When the exchange coupling interaction occurs between the soft magnetic phase and the hard magnetic phase, in the case where the field is reversed, the magnetic reversal of the soft magnetic phase is suppressed by the magnetization of the hard magnetic phase coupled to the soft magnetic phase by exchange coupling. In this case, the magnetization curve of the soft magnetic phase and the hard magnetic phase behaves as a magnetization curve of a single-phase magnet due to the exchange coupling interaction. Thus, a magnetization curve showing a high saturated magnetic flux density of the soft magnetic phase and a strong coercive force of the hard magnetic phase is obtained. As a result, a high energy product (BH)ₘₐₓ is achieved. Such a magnet in which the exchange coupling interaction occurs between the soft magnetic phase and the hard magnetic phase as described above is known as a nano-composite magnet or an exchange spring magnet.

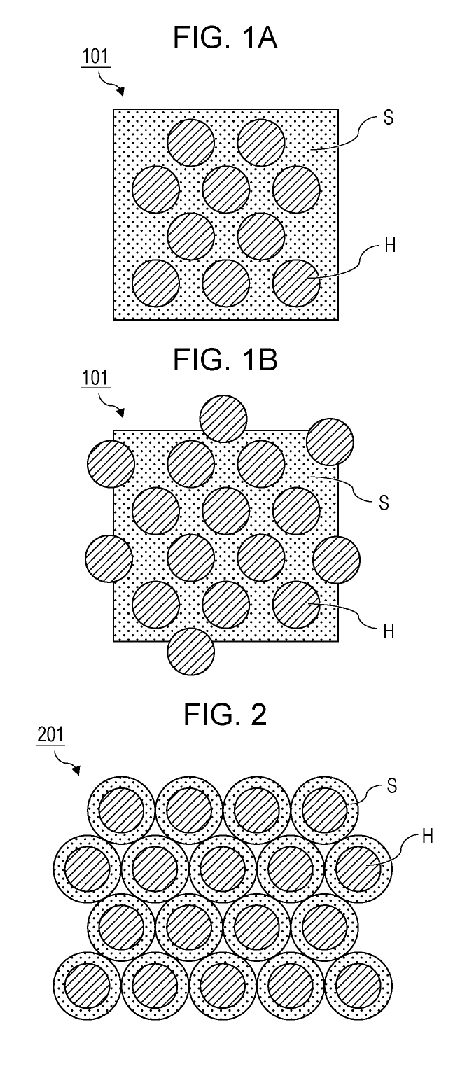

FIGS. 1A and 1B are schematic illustrations of an exemplary structure of the composite magnetic material according to the first embodiment. As shown in FIGS. 1A and 1B, a composite magnetic material 101 according to the present embodiment has a sea-island structure that has island portions including a hard magnetic material H in a sea portion including a soft magnetic material S.

### Soft Magnetic Material S

The soft magnetic material S is a material that has a higher saturated magnetic flux density than the hard magnetic material H. The saturated magnetic flux density of the soft magnetic material S is preferably, but not particularly limited to, 50 emu/g or more, more preferably 70 emu/g or more.

The soft magnetic material S contains elemental iron, and 90 atom % or more and 100 atom % or less of the elemental iron contained in the soft magnetic material S forms a first oxide or a first composite oxide. When the elemental iron contained in the soft magnetic material S forms iron or a ferrous alloy, the elemental iron is likely to be oxidized, and the temporal stability of the magnetic properties of the soft magnetic material S may decrease. In the present embodiment, 90 atom % or more of the elemental iron contained in the soft magnetic material S forms the first oxide or the first composite oxide. Therefore, the elemental iron is less likely to be oxidized, and the temporal decrease in the magnetic properties of the soft magnetic material S can be suppressed.

The first oxide or the first composite oxide that is formed of the elemental iron contained in the soft magnetic material S can contain Fe₃O₄ or a composite oxide in which Fe in Fe₃O₄ is partly substituted by at least one selected from the group consisting of Ga, Al, Ni, and Co. When the soft magnetic material S contains Fe₃O₄ (magnetite), which has high stability in the atmosphere, the temporal stability of the composite magnetic material 101 more effectively improves. In addition, among iron-based oxide materials, Fe₃O₄ has a particularly high saturated magnetic flux density. Thus, when the soft magnetic material S contains Fe₃O₄, the saturated magnetic flux density of the composite magnetic material 101 increases, and the energy product (BH)ₘₐₓ further increases.

The first oxide or the first composite oxide that is formed of the elemental iron contained in the soft magnetic material S can contain γ-Fe₂O₃ or a composite oxide in which Fe in γ-Fe₂O₃ is partly substituted by at least one selected from the group consisting of Ga, Al, Ni, and Co. When the soft magnetic material S contains γ-Fe₂O₃, which has high stability in the atmosphere, the temporal stability of the composite magnetic material 101 more effectively improves.

The first oxide or the first composite oxide formed of the elemental iron contained in the soft magnetic material S may contain α-Fe₂O₃ or a composite oxide in which Fe in α-Fe₂O₃ is partly substituted by at least one selected from the group consisting of Ga, Al, Ni, and Co.

### Hard Magnetic Material H

The hard magnetic material H has a higher coercive force than the soft magnetic material S. The coercive force of the hard magnetic material H is preferably, but not particularly limited to, 500 Oe or more, more preferably 1000 Oe or more.

The hard magnetic material H contains elemental iron, and 90 atom % or more and 100 atom % or less of the elemental iron contained in the hard magnetic material H forms a second oxide or a second composite oxide. When the elemental iron contained in the hard magnetic material H forms iron or a ferrous alloy, the elemental iron is likely to be oxidized, and the temporal stability of the magnetic properties of the hard magnetic material H may decrease. In the present embodiment, 90 atom % or more of the elemental iron contained in the hard magnetic material H forms the second oxide or the second composite oxide. Therefore, the elemental iron is less likely to be oxidized, and the temporal decrease in the magnetic properties of the hard magnetic material H can be suppressed.

The second oxide or the second composite oxide that is formed of the elemental iron contained in the hard magnetic material H can contain ε-Fe₂O₃ or a composite oxide in which Fe in ε-Fe₂O₃ is partly substituted by at least one selected from the group consisting of Ga, Al, Ni, and Co. When the hard magnetic material H contains ε-Fe₂O₃, which has high stability in the atmosphere, the temporal stability of the composite magnetic material 101 more effectively improves. In addition, among iron-based oxide materials, ε-Fe₂O₃ has a particularly high coercive force. Thus, when the hard magnetic material H contains ε-Fe₂O₃, the coercive force of the composite magnetic material 101 increases, and the energy product (BH)ₘₐₓ further increases.

### Elements Included in Composite Magnetic Material

When the total amount of the composite magnetic material 101 is taken as 100 mass %, the composite magnetic material 101 according to the present embodiment preferably has an elemental Nd content of 0 mass % or more and 3 mass % or less, more preferably 0 mass % or more and 1 mass % or less. The composite magnetic material 101 particularly preferably contains substantially no elemental Nd. The cost of the composite magnetic material 101 can be decreased by decreasing the content of elemental Nd in the composite magnetic material 101.

When the total amount of the elemental iron contained in the composite magnetic material 101 is taken as 100 atom %, 90 atom % or more and 100 atom % or less of the elemental iron contained in the composite magnetic material 101 according to the present embodiment can form an oxide or a composite oxide.

### Structure

The composite magnetic material 101 according to the present embodiment has a sea-island structure that has a sea portion including the soft magnetic material S and island portions including the hard magnetic material H.

In the present embodiment, the sea portion includes the soft magnetic material S, and the island portions include the hard magnetic material H; however, the sea portion may include the hard magnetic material H, and the island portions may include the soft magnetic material S.

The soft magnetic material S and the hard magnetic material H can be magnetically coupled to each other by an exchange coupling interaction. To achieve this, when the distance at which the exchange coupling interaction occurs from the interface between the island portion and the sea portion (hereinafter, referred to as “exchange coupling distance”) is assumed to be a, the average distance d between two adjacent island portions can satisfy d≤2a in the composite magnetic material 101. In other words, the average distance between two adjacent island portions can be twice or less the exchange coupling distance.

The average particle size of the particulate island portions including the hard magnetic material H can be sufficiently large so as not to decrease the coercive force of the hard magnetic material H. When the hard magnetic material H contains ε-Fe₂O₃, the average particle size of the particulate island portions including the hard magnetic material H can be small enough for ε-Fe₂O₃ to retain its epsilon structure. Specifically, the average particle size of the particulate island portions including the hard magnetic material H is preferably 5 nm or more and 60 nm or less, more preferably 10 nm or more and 40 nm or less.

### Method for Producing Composite Magnetic Material

Examples of the method for producing the composite magnetic material 101 according to the present embodiment include, but not limited to, the following methods.

A first method includes providing particles of the soft magnetic material S and particles of the hard magnetic material H separately and mixing the above particles with each other at an appropriate mixing ratio. After the mixture is compacted, heat treatment may be performed.

When Fe₃O₄ is used as the soft magnetic material S, Fe₃O₄ nanoparticles can be relatively easily synthesized by producing nanoparticles of iron oxide or iron hydroxide by a chemical process in a solution and heat-treating the produced nanoparticles in a reducing atmosphere. In heat treatment in a reducing atmosphere, if heat treatment temperature is excessively high or if heat treatment time is excessively long, reduction excessively proceeds, and α-Fe may be produced. Thus, the heat treatment temperature is preferably 200° C. or more and 400° C. or less, and the heat treatment time is preferably 2 hours or more and 5 hours or less.

When γ-Fe₂O₃ is used as the soft magnetic material S, γ-Fe₂O₃ nanoparticles can be relatively easily synthesized by producing nanoparticles of iron oxide or iron hydroxide by a chemical process in a solution and heat-treating the produced nanoparticles in an oxidizing atmosphere. For example, the heat treatment temperature is preferably 200° C. or more and 400° C. or less, and the heat treatment time is preferably 2 hours or more and 5 hours or less.

When ε-Fe₂O₃ is used as the hard magnetic material H, ε-Fe₂O₃ particles can be relatively easily synthesized by producing nanoparticles of iron oxide or iron hydroxide by a chemical process in a solution and heat-treating the produced nanoparticles in an oxidizing atmosphere. Examples of the chemical process in a solution include a sol-gel method and a reverse micelle method in which an iron nitrate hydrate is used as a starting material. The process of synthesizing ε-Fe₂O₃ particles may include a process of coating the surface of ε-Fe₂O₃ particles with silica (SiO₂).

A second method is a method of partly changing one magnetic material into the other magnetic material by providing particles of the soft magnetic material S or particles of the hard magnetic material H and processing the particles of the soft magnetic material S or the particles of the hard magnetic material H.

When Fe₃O₄ is used as the soft magnetic material S and ε-Fe₂O₃ is used as the hard magnetic material H, for example, there is a method that includes synthesizing ε-Fe₂O₃ particles by the above-described method and then heat-treating the ε-Fe₂O₃ particles in a reducing atmosphere. This partly deoxidizes ε-Fe₂O₃ to thereby produce Fe₃O₄. In this case, a core-shell composite magnetic material that will be described in the second embodiment is produced.

A third method includes providing a dispersion liquid in which particles of one of the soft magnetic material S and the hard magnetic material H are dispersed in a solution in which a raw material of the other of the two is dissolved and depositing magnetic material particles or precursor particles thereof from the raw material in this dispersion liquid. Subsequently, the powder of the obtained composite particles may be heat-treated.

For example, in order to obtain a dispersion liquid, particles of the hard magnetic material H (hard magnetic particles) are dispersed in a solution in which at least one transition metal element contained in the soft magnetic material S is ionized and dissolved. Subsequently, an additive, such as a pH adjuster, is added to the dispersion liquid with stirring to deposit particles containing the transition metal. Here, the deposited particles may be particles of the intended soft magnetic material S or precursor particles that can be changed into the soft magnetic material S by subsequent treatment, such as heat treatment. Since the hard magnetic particles are dispersed in the dispersion liquid, the above-described ions are present around the hard magnetic particles in the dispersion liquid so as to surround the hard magnetic particles. The reaction of the ions in such a condition results in the deposition of deposits or particles containing the transition metal element in the ions. Accordingly, the particles or the deposits are deposited so as to surround the periphery of the hard magnetic particles. Even if the soft magnetic material S is replaced with the hard magnetic material H, a composite magnetic material can be formed in the same method.

For example, when a raw material containing trivalent iron, such as iron(III) chloride, iron(III) sulfate, or iron(III) nitrate, is dissolved in water to obtain an aqueous solution containing Fe³⁺ ions and ammonia water serving as a pH adjuster is added to the obtained solution to change the pH, iron hydroxide (Fe(OH)₃) is deposited. According to this method, the average particle size of the deposited iron hydroxide particles depends on deposition conditions and is about 5 nm to 15 nm. This iron hydroxide is subjected to reduction treatment in the same manner as in the first method, so that Fe₃O₄ serving as the soft magnetic material S can be obtained.

When a raw material containing bivalent iron, such as iron(II) chloride, is dissolved in water to obtain an aqueous solution containing Fe² ion and ammonia water serving as a pH adjuster is added to the obtained solution to change the pH, Fe₃O₄ particles are deposited. According to this method, the average particle size of the deposited Fe₃O₄ particles depends on deposition conditions and is about 13 nm to 100 nm.

### Magnet

The composite magnetic material according to the present embodiment can be formed into a nano-composite magnet having a desired form. The nano-composite magnet according to the present embodiment includes a soft magnetic material and a hard magnetic material. The hard magnetic material contains iron or a ferrous alloy, and the surface of the soft magnetic material is covered with a crystalline iron oxide. The nano-composite magnet according to the present embodiment may be a sintered magnet or a bonded magnet.

### 1. Sintered Magnet

The composite magnetic material according to the present embodiment is molded into a desired form, and the obtained molded body is heat-treated in an inert atmosphere or in a vacuum to thereby obtain a sintered magnet. The molded body is also sintered by plasma activated sintering (PAS) or by spark plasma sintering (SPS) to obtain a sintered magnet. An anisotropic bonded magnet can be obtained by molding the composite magnetic material in a magnetic field.

### 2. Bonded Magnet

The composite magnetic material according to the present embodiment and a binder are mixed and molded to obtain a bonded magnet. Examples of the binder include resin materials, such as thermoplastic resins and thermosetting resins; low melting point metals, such as Al, Pb, Sn, Zn and Mg; and alloys formed of the above low melting point metals. A mixture of the composite magnetic material and a binder is subjected to compression molding or injection molding, so that the composite magnetic material can be molded into a desired form. An anisotropic bonded magnet can be obtained by molding the composite magnetic material in a magnetic field.

### Motor

The composite magnetic material according to the present embodiment can be suitably used as a material for forming a rotor in a motor. In other words, the motor according to the present embodiment includes a magnet, and the magnet includes the composite magnetic material according to the present embodiment.

### Second Embodiment

FIG. 2 is a schematic illustration of an exemplary structure of the composite magnetic material according to the second embodiment. A composite magnetic material 201 according to the present embodiment has, as shown in FIG. 2, a core-shell structure that has a core portion including the hard magnetic material H and a shell portion that includes the soft magnetic material S and covers at least a part of the core portion. The descriptions of the hard magnetic material H, the soft magnetic material S, and the like that are included in the composite magnetic material 201, which are similar to those in the first embodiment, will be omitted where appropriate.

### Structure

The composite magnetic material 201 according to the present embodiment has a core-shell structure that has a core portion including the hard magnetic material H and a shell portion that includes the soft magnetic material S and covers at least a part of the core portion. As shown in FIG. 2, the composite magnetic material 201 may be an aggregate of a plurality of core-shell particles.

The soft magnetic material S and the hard magnetic material H can be magnetically coupled to each other by the exchange coupling interaction. Accordingly, when a distance at which the exchange coupling interaction occurs from the interface between the core portion and the shell portion (hereinafter, referred to as “exchange coupling distance”) is defined as a, a shell-portion thickness t can satisfy t≤a. In other words, the shell-portion thickness can equal the exchange coupling distance or less.

The average particle size of the core portions including the hard magnetic material H can be sufficiently large so as not to decrease the coercive force of the hard magnetic material H. When the hard magnetic material H contains ε-Fe₂O₃, the average particle size of the core portions including the hard magnetic material H can be small enough for ε-Fe₂O₃ to retain its epsilon structure. Specifically, the average particle size of the core portions including the hard magnetic material H is preferably 5 nm or more and 60 nm or less, more preferably 10 nm or more and 40 nm or less.

### EXAMPLES

Hereinafter, the present disclosure will be described in detail with reference to Examples, but the following Examples below are not intended to limit the technical scope of the present disclosure. Note that “%” is on a mass basis unless otherwise specified.

### Example 1

In Example 1, Fe₃O₄ nanoparticles and ε-Fe₂O₃ particles were separately produced, mixed with each other, and heat-treated to thereby produce a composite magnetic material containing Fe₃O₄ and ε-Fe₂O₃.

Production of Fe₃O₄ Nanoparticles

Fe₃O₄ nanoparticles serving as a soft magnetic material were produced by the following procedure.

First, 6 g of iron nitrate hydrate (Fe(NO₃)₃.9H₂O) was weighed and dissolved in 75 mL of pure water to obtain an aqueous iron nitrate solution. The aqueous iron nitrate solution was added to 75 mL of 28% ammonia water with stirring to deposit iron hydroxide (Fe(OH)₃). The deposited iron hydroxide was collected by filter filtration, washed sufficiently with pure water, and then vacuum-dried to obtain iron hydroxide nanoparticles. The particle size of the obtained iron hydroxide nanoparticles was measured by dynamic light scattering (DLS) to find that the volume average particle size was 8 nm.

Next, the obtained iron hydroxide nanoparticles were placed into an alumina crucible and heat-treated in a reducing atmosphere to thereby obtain Fe₃O₄ nanoparticles. As an ambient gas of the heat treatment, a gas mixture of 2% hydrogen-98% nitrogen was used and the flow rate of the gas mixture was set to 300 sccm. The temperature of the heat treatment was set at 350° C., kept at 350° C. for 3 hours, and then decreased to room temperature. The particle size of the obtained Fe₃O₄ nanoparticles was measured by dynamic light scattering (DLS) to find that the volume average particle size was 18 nm. The crystal structure of the obtained Fe₃O₄ nanoparticles was evaluated by X-ray diffraction (XRD), and as a result, the diffraction peaks of magnetite (Fe₃O₄) were confirmed, but diffraction peaks derived from other crystal structures were not confirmed.

Production of ε-Fe₂O₃ Particles

ε-Fe₂O₃ particles serving as a hard magnetic material were produced by the following procedure.

(1) First, two kinds of micelle solutions (micelle solution (A) and micelle solution (B)) were prepared as follows.

(1-1) Into a reaction container, 30 mL of pure water, 92 mL of n-octane, and 19 mL of 1-butanol were placed and mixed with each other. To the resulting mixture, 6 g of iron nitrate hydrate (Fe(NO)₃.9H₂O) was added and sufficiently dissolved with stirring. Next, cetyltrimethylammonium bromide serving as a surfactant was added to the resulting solution such that a mole ratio expressed as (number of moles of pure water)/(number of moles of surfactant) equaled 30 and dissolved by performing stirring. Accordingly, the micelle solution (A) was obtained.

(1-2) Into another reaction container, 10 mL of 28% ammonia water and 20 mL of pure water were placed, mixed with each other, and stirred. Then, 92 mL of n-octane and 19 mL of 1-butanol were further added thereto and thoroughly stirred. Cetyltrimethylammonium bromide serving as a surfactant was added to the resulting solution such that a mole ratio expressed as (number of moles of (pure water+water in ammonia water)/(number of moles of surfactant) equaled 30 and dissolved by performing stirring. Accordingly, the micelle solution (B) was obtained.

(2) The micelle solution (B) was added dropwise to the micelle solution (A) while the micelle solution (A) was thoroughly stirred. After the dropwise addition, stirring was continued for 30 minutes.

(3) While the obtained mixed solution was stirred, 7.5 mL of tetraethoxysilane (TEOS) was added thereto, and the stirring was continued for one day. In this process, a silica layer was formed on the surface of iron-containing particles included in the mixed solution.

(4) The obtained solution was set into a centrifugal separator and centrifuged at 4500 rpm for 30 minutes, and a precipitate was collected. The collected precipitate was washed with ethanol a plurality of times.

(5) After being dried, the obtained precipitate was placed into a firing furnace in the air atmosphere and heat-treated at 1150° C. for 4 hours.

(6) The powder obtained by the heat treatment was dispersed in 2 mol/L aqueous NaOH solution, and stirring was performed for 24 hours to remove the silica layer from the particle surface. Subsequently, filtering, washing with water, and drying were performed to thereby obtain ε-Fe₂O₃ particles. The crystal structure of the obtained ε-Fe₂O₃ particles was evaluated by XRD, and as a result, the diffraction peaks of ε-Fe₂O₃ were confirmed, but diffraction peaks derived from other crystal structures were not confirmed.

### Production of Composite Magnetic Material

The Fe₃O₄ nanoparticles and the ε-Fe₂O₃ particles that had been separately produced by the above-described methods were weighed (0.31 g and 0.2 g, respectively) and mixed with each other by using a planetary ball mill in a nitrogen atmosphere. Next, this powder mixture was processed by using a pressure molding machine to thereby obtain a molded body.

The obtained molded body was set into an electric furnace and heat-treated at 270° C. for 5 hours in a mixed gas atmosphere of hydrogen and nitrogen (2% H₂ and 98% N₂). After being cooled to room temperature, the molded body was coarsely ground by using a planetary ball mill in a nitrogen atmosphere. The powder obtained by coarse grinding was set into the electric furnace again and heat-treated at 270° C. for 3 hours in a mixed gas atmosphere of hydrogen and nitrogen (2% H₂ and 98% N₂) to thereby obtain a composite magnetic material 1.

### Structural Analysis of Composite Magnetic Material

The crystal structure of the obtained composite magnetic material 1 was evaluated by XRD, and as a result, the diffraction peaks of ε-Fe₂O₃ and magnetite (Fe₃O₄) were confirmed, but diffraction peaks derived from other crystal structures were not confirmed.

As a result of the observation of a section of the particulate composite magnetic material 1 by using a TEM, a sea-island structure in which a plurality of islands formed of ε-Fe₂O₃ were present in a sea (a continuous phase) formed of Fe₃O₄ was confirmed.

### Evaluation of Magnetic Properties of Composite Magnetic Material

The temporal stability of the magnetic properties of the obtained composite magnetic material 1 was evaluated. Immediately after the composite magnetic material was produced, a residual magnetic flux density and a coercive force were measured by using a vibrating sample magnetometer. After the material was stored at room temperature for 30 days in the air atmosphere, a residual magnetic flux density and a coercive force were measured again in the same manner. The temporal stability of the magnetic properties was evaluated based on the ratio (retention ratio) of residual magnetic flux density measured after 30 days to that measured immediately after production and the ratio (retention ratio) of the coercive force measured after 30 days to that measured immediately after production. Table 1 shows the results.

### Example 2

In Example 2, ε-Fe₂O₃ particles were heat-treated in a reducing atmosphere to thereby deoxidize the surface of the ε-Fe₂O₃ particles, so that a core-shell-particulate composite magnetic material having a core formed of α-Fe₂O₃ particles and a shell that was formed of Fe₃O₄ and covered the core was produced.

Production of ε-Fe₂O₃ Particles

In the same manner as in Example 1, ε-Fe₂O₃ particles were produced.

### Production of Composite Magnetic Material

The produced ε-Fe₂O₃ particles were set into an electric furnace and heat-treated at 250° C. for 30 minutes in a mixed gas atmosphere of hydrogen and nitrogen (2% H₂ and 98% N₂). After being cooled to room temperature, the particles were coarsely ground by using a planetary ball mill in a nitrogen atmosphere. The powder obtained by coarse grinding was set into the electric furnace again and heat-treated at 250° C. for 30 minutes in a mixed gas atmosphere of hydrogen and nitrogen (2% H₂ and 98% N₂) to thereby obtain a composite magnetic material 2.

### Structural Analysis of Composite Magnetic Material

The crystal structure of the obtained composite magnetic material 2 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 2 by using a TEM, it was confirmed that a magnetite (Fe₃O₄) layer was formed in the surface layer of ε-Fe₂O₃ particles.

### Evaluation of Magnetic Properties of Composite Magnetic Material

The temporal stability of the magnetic properties of composite magnetic material 2 was evaluated in the same manner as in Example 1. Table 1 shows the results.

### Example 3

A composite magnetic material 3 was produced in the same manner as in Example 1, except that the ambient gas of the heat treatment in “Production of Fe₃O₄ nanoparticles” and the ambient gas of the heat treatment in “Production of Composite Magnetic Material” in Example 1 were changed from the mixed gas of 2% hydrogen and 98% nitrogen to hydrogen gas.

### Structural Analysis of Composite Magnetic Material

The crystal structure of the obtained composite magnetic material 3 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 3 by using a TEM, a sea-island structure in which a plurality of islands formed of α-Fe₂O₃ were present in a sea (a continuous phase) formed of Fe₃O₄ was confirmed.

### Evaluation of Magnetic Properties of Composite Magnetic Material

The temporal stability of the magnetic properties of the composite magnetic material 3 was evaluated in the same manner as in Example 1. Table 1 shows the results.

### Example 4

A composite magnetic material 4 was produced in the same manner as in Example 3, except that the temperature of the heat treatment in “Production of Fe₃O₄ Nanoparticles” and the temperature of the heat treatment in “Production of Composite Magnetic Material” in Example 3 were changed from 350° C. to 370° C.

### Structural Analysis of Composite Magnetic Material

The crystal structure of the obtained composite magnetic material 4 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 4 by using a TEM, a sea-island structure in which a plurality of islands formed of ε-Fe₂O₃ were present in a sea (a continuous phase) formed of Fe₃O₄ was confirmed.

### Evaluation of Magnetic Properties of Composite Magnetic Material

The temporal stability of the magnetic properties of the composite magnetic material 4 was evaluated in the same manner as in Example 1. Table 1 shows the result.

### Example 5

In Example 5, γ-Fe₂O₃ nanoparticles and ε-Fe₂O₃ particles were separately produced, mixed with each other, and heat-treated to thereby produce a composite magnetic material containing γ-Fe₂O₃ and ε-Fe₂O₃.

Production of γ-Fe₂O₃ Nanoparticle

γ-Fe₂O₃ nanoparticles serving as a soft magnetic material were produced by the following procedures.

First, 6 g of iron nitrate hydrate (Fe(NO₃)₃.9H₂O) was weighed and dissolved in 75 mL of pure water to obtain an aqueous iron nitrate solution. The aqueous iron nitrate solution was added to 75 mL of 28% ammonia water with stirring to deposit iron hydroxide (Fe(OH)₃). The deposited iron hydroxide was collected by filter filtration, washed sufficiently with pure water, and then vacuum-dried to obtain iron hydroxide nanoparticles. The particle size of the obtained iron hydroxide nanoparticles was measured by dynamic light scattering (DLS) to find that the volume average particle size was 8 nm.

Next, the obtained iron hydroxide nanoparticles were placed into an alumina crucible and heat-treated in an oxidizing atmosphere to thereby obtain γ-Fe₂O₃ nanoparticles. As an ambient gas of the heat treatment, the air was used and the flow rate of the air was set to 300 sccm. The temperature of the heat treatment was set at 350° C., kept at 350° C. for 3 hours, and then decreased to room temperature. The particle size of the obtained γ-Fe₂O₃ nanoparticles was measured by dynamic light scattering (DLS), and as a result, the volume average particle size was 20 nm. The crystal structure of the obtained γ-Fe₂O₃ nanoparticles was evaluated by X-ray diffraction (XRD), and as a result, the diffraction peaks of γ-Fe₂O₃ were confirmed, but diffraction peaks derived from other crystal structures were not confirmed.

Production of ε-Fe₂O₃ Particles

In the same manner as in Example 1, ε-Fe₂O₃ particles were produced.

### Production of Composite Magnetic Material

The γ-Fe₂O₃ nanoparticles and the ε-Fe₂O₃ particles that had been separately produced by the above-described methods were weighed (0.32 g and 0.2 g, respectively) and mixed with each other by using a planetary ball mill in a nitrogen atmosphere. Next, this powder mixture was processed by using a pressure molding machine to thereby obtain a molded body.

The obtained molded body was set into an electric furnace and heat-treated at 270° C. for 5 hours in an air atmosphere. After being cooled to room temperature, the molded body was coarsely ground by using a planetary ball mill in a nitrogen atmosphere. The powder obtained by coarse grinding was set into the electric furnace again and heat-treated at 270° C. for 3 hours in the air atmosphere to thereby obtain a composite magnetic material 5.

### Structural Analysis of Composite Magnetic Material

The crystal structure of the obtained composite magnetic material 5 was evaluated by XRD, and as a result, the diffraction peaks of ε-Fe₂O₃ and γ-Fe₂O₃ were confirmed, but diffraction peaks derived from other crystal structures were not confirmed.

As a result of observing a section of the particulate composite magnetic material 5 by using a TEM, a composite structure of ε-Fe₂O₃ and γ-Fe₂O₃ was confirmed.

### Evaluation of Magnetic Properties of Composite Magnetic Material

The temporal stability of the magnetic properties of the composite magnetic material 5 was evaluated in the same manner as in Example 1. Table 1 shows the results.

### Comparative Example 1

In Comparative Example 1, α-Fe nanoparticles and ε-Fe₂O₃ particles were produced separately, mixed with each other, and heat-treated to produce a composite magnetic material containing α iron (α-Fe) and ε-Fe₂O₃.

### Production of α-Fe Nanoparticles

α-Fe nanoparticles serving as a soft magnetic material were produced by the following procedure.

First, iron hydroxide nanoparticles were obtained in the same manner as in Example 1. The particle size of the obtained iron hydroxide nanoparticles was measured by dynamic light scattering (DLS) to find that the volume average particle size was 8 nm.

Next, the obtained iron hydroxide nanoparticles were placed into an alumina crucible and heat-treated in a reducing atmosphere to thereby obtain α-Fe nanoparticles. As an ambient gas of the heat treatment, a gas mixture of 2% hydrogen-98% nitrogen was used, and the flow rate of the gas mixture was set to 300 sccm. The temperature of the heat treatment was set at 500° C., kept at 500° C. for 5 hours, and then decreased to room temperature. The particle size of the obtained α-Fe nanoparticles was measured by dynamic light scattering (DLS) to find that the volume average particle size was 25 nm. The crystal structure of the obtained α-Fe nanoparticles was evaluated by XRD, and as a result, the diffraction peaks of α-Fe (alfa iron) were confirmed, but diffraction peaks derived from other crystal structures were not confirmed.

Production of ε-Fe₂O₃ Particles

In the same manner as in Example 1, ε-Fe₂O₃ particles were produced.

### Production of Composite Magnetic Material

The α-Fe nanoparticles and the ε-Fe₂O₃ particles that had been separately produced by the above-described methods were weighed (0.48 g and 0.2 g, respectively) and mixed with each other by using a planetary ball mill in a nitrogen atmosphere. Next, this powder mixture was processed by using a pressure molding machine to thereby obtain a molded body.

The obtained molded body was set into an electric furnace and heat-treated at 260° C. for 5 hours in a mixed gas atmosphere of hydrogen and nitrogen (2% H₂ and 98% N₂). After being cooled to room temperature, the molded body was coarsely ground by using a planetary ball mill in a nitrogen atmosphere. The powder obtained by coarse grinding was set into the electric furnace again and heat-treated at 260° C. for 3 hours in a mixed gas atmosphere of hydrogen and nitrogen (2% H₂ and 98% N₂) to thereby obtain a composite magnetic material 6.

### Structural Analysis of Composite Magnetic Material

The crystal structure of the obtained composite magnetic material 6 was evaluated by XRD, and as a result, the diffraction peaks of ε-Fe₂O₃ and α-Fe were confirmed, but diffraction peaks derived from other crystal structures were not confirmed.

As a result of observing a section of the particulate composite magnetic material 6 by using a TEM, a composite structure of ε-Fe₂O₃ and α-Fe was confirmed. An amorphous iron oxide layer having a thickness of about 3 nm was formed in the surface layer of α-Fe exposed on the particle surface.

### Evaluation of Magnetic Properties of Composite Magnetic Material

The temporal stability of the magnetic properties of the composite magnetic material 6 was evaluated in the same manner as in Example 1. Table 1 shows the results.

### Comparative Example 2

In Comparative Example 2, ε-Fe₂O₃ particles were heat-treated in a reducing atmosphere to deoxidize the surface of the ε-Fe₂O₃ particles, so that a core-shell-particulate composite magnetic material having a core formed of an ε-Fe₂O₃ particle and a shell that was formed of α-Fe and covered the core was produced.

Production of ε-Fe₂O₃ Particles

In the same manner as in Example 1, ε-Fe₂O₃ particles were produced.

### Production of Composite Magnetic Material

The produced ε-Fe₂O₃ particles were set into an electric furnace and heat-treated at 500° C. for 30 minutes in a mixed gas atmosphere of hydrogen and nitrogen (2% H₂ and 98% N₂). After being cooled to room temperature, the particles were coarsely ground by using a planetary ball mill in a nitrogen atmosphere. The powder obtained by coarse grinding was set into the electric furnace again and heat-treated at 500° C. for 30 minutes in a mixed gas atmosphere of hydrogen and nitrogen (2% H₂ and 98% N₂) to thereby obtain a composite magnetic material 7.

### Structural Analysis of Composite Magnetic Material

The crystal structure of the obtained composite magnetic material 7 was evaluated by XRD, and as a result, the diffraction peaks of ε-Fe₂O₃ and α-Fe were confirmed, but diffraction peaks derived from other crystal structures were not confirmed.

As a result of observing a section of the particulate composite magnetic material 7 by using a TEM, it was confirmed that an α-Fe layer was formed so as to cover the ε-Fe₂O₃ particles. Furthermore, an amorphous iron oxide layer having a thickness of about 3 nm was formed in the surface layer of α-Fe exposed on the particle surface.

### Evaluation of Magnetic Properties of Composite Magnetic Material

The temporal stability of the magnetic properties of the composite magnetic material 7 was evaluated in the same manner as in Example 1. Table 1 shows the results.

### Example 6

In Example 6, in a dispersion liquid in which ε-Fe₂O₃ particles were dispersed, Fe(OH)₃ particles were deposited and heat-treated to produce a composite magnetic material containing Fe₃O₄ and ε-Fe₂O₃.

### Production of Dispersion Liquid

Six grams of iron nitrate hydrate (Fe(NO₃)₃.9H₂O) was weighed and dissolved in 75 mL of pure water to obtain an aqueous iron nitrate solution. Next, 0.36 g of ε-Fe₂O₃ particles obtained in the same manner as in Comparative Example 1 were weighed, added to the aqueous iron nitrate solution, and thoroughly dispersed by using an ultrasonic disperser to produce a dispersion liquid.

### Deposition of Precursor Particles

To the produced dispersion liquid, 75 mL of 28% ammonia water was added with stirring to deposit Fe(OH)₃ particles serving as precursor particles of Fe₃O₄, and thus composite particles including Fe(OH)₃ particles and ε-Fe₂O₃ particles were formed. The particle size of the Fe(OH)₃ particles in the obtained composite particles was measured by observation with a SEM and found to be 10 nm to 20 nm.

### Production of Composite Magnetic Material

The Fe(OH)₃ particles were changed into Fe₃O₄ through deoxidization to produce a composite magnetic material. One gram of the powder of the composite particles including Fe(OH)₃ particles and ε-Fe₂O₃ particles was processed by using a pressure molding machine to thereby obtain a molded body.

The obtained molded body was set into an electric furnace and heat-treated at 350° C. for 5 hours in a mixed gas atmosphere of hydrogen and nitrogen (2% H₂ and 98% N₂). The flow rate of the gas mixture was set to 300 sccm. After being cooled to room temperature, the molded body was coarsely ground by using a planetary ball mill in a nitrogen atmosphere. The powder obtained by coarse grinding was set into the electric furnace again and heat-treated at 270° C. for 3 hours in the air atmosphere to thereby obtain a composite magnetic material 8.

### Structural Analysis of Composite Magnetic Material

The crystal structure of the obtained composite magnetic material 8 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 8 by using a TEM, a sea-island structure in which a plurality of islands formed of ε-Fe₂O₃ were present in a sea (a continuous phase) formed of Fe₃O₄ was confirmed.

### Evaluation of Magnetic Properties of Composite Magnetic Material

The temporal stability of the magnetic properties of the composite magnetic material 8 was evaluated in the same manner as in Example 1. Table 1 shows the results.

### Example 7

In Example 7, in a dispersion liquid in which ε-Fe₂O₃ particles were dispersed, Fe₃O₄ particles were deposited to produce a composite magnetic material containing Fe₃O₄ and ε-Fe₂O₃.

### Production of Dispersion Liquid

Three grams of iron chloride hydrate (FeCl₂.4H₂O) was weighed and dissolved in 75 mL of pure water to obtain an aqueous iron chloride solution. Next, 0.36 g of ε-Fe₂O₃ particles obtained in the same manner as in Comparative Example 1 were weighed, added to the aqueous iron chloride solution, and thoroughly dispersed by using an ultrasonic disperser to produce a dispersion liquid.

### Deposition of Precursor Particles

To the produced dispersion liquid, 75 mL of 28% ammonia water was added with stirring to deposit Fe₃O₄ particles, and thus composite particles including Fe₃O₄ particles and ε-Fe₂O₃ particles were formed. The particle size of the Fe₃O₄ particles in the obtained composite particles was measured by a SEM and found to be 50 nm to 80 nm.

### Production of Composite Magnetic Material

The powder of the obtained composite particles was heat-treated to produce a composite magnetic material. One gram of the composite particles including Fe₃O₄ particles and ε-Fe₂O₃ particles were processed by using a pressure molding machine to produce a molded body.

The obtained molded body was set into an electric furnace and heat-treated at 410° C. for 5 hours in a nitrogen atmosphere. The flow rate of the nitrogen gas was set to 300 sccm. After being cooled to room temperature, the molded body was coarsely ground by using a planetary ball mill in a nitrogen atmosphere. The powder obtained by coarse grinding was set into the electric furnace again and heat-treated at 270° C. for 3 hours in the air atmosphere to thereby obtain a composite magnetic material 9.

### Structural Analysis of Composite Magnetic Material

The crystal structure of the obtained composite magnetic material 9 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 9 by using a TEM, a sea-island structure in which a plurality of islands formed of ε-Fe₂O₃ were present in a sea (a continuous phase) formed of Fe₃O₄ was confirmed.

### Evaluation of Magnetic Properties of Composite Magnetic Material

The temporal stability of the magnetic properties of the composite magnetic material 9 was evaluated in the same manner as in Example 1. Table 1 shows the results.

### Example 8

In Example 8, in a dispersion liquid in which ε-Fe₂O₃ particles were dispersed, Fe₃O₄ particles were deposited to produce a composite magnetic material containing Fe₃O₄ and ε-Fe₂O₃. In Example 8, the composite magnetic material was produced by decreasing the particle size of the deposited Fe₃O₄ particles relative to that in Example 7.

### Production of Dispersion Liquid

Iron chloride hydrate (FeCl₂.4H₂O) (1.5 g) was weighed and dissolved in 150 mL of pure water to obtain an aqueous iron chloride solution. Next, 0.18 g of ε-Fe₂O₃ particles obtained in the same manner as in Comparative Example 1 were weighed, added to the aqueous iron chloride solution, and thoroughly dispersed by using an ultrasonic disperser to produce a dispersion liquid.

### Deposition of Precursor Particles

To the produced dispersion liquid, 75 mL of 28% ammonia water was added with stirring to deposit Fe₃O₄ particles, and thus composite particles including Fe₃O₄ particles and ε-Fe₂O₃ particles were formed. The particle size of the Fe₃O₄ particles in the obtained composite particles was measured by observation with a SEM and found to be 10 nm to 30 nm.

### Production of Composite Magnetic Material

The powder of the obtained composite particles was heat-treated to produce a composite magnetic material. One gram of the powder of the composite particles including Fe₃O₄ particles and ε-Fe₂O₃ particles was processed by using a pressure molding machine to produce a molded body.

The obtained molded body was set into an electric furnace and heat-treated at 400° C. for 5 hours in a nitrogen atmosphere. The flow rate of the nitrogen gas was set to 300 sccm. After being cooled to room temperature, the molded body was coarsely ground by using a planetary ball mill in a nitrogen atmosphere. The powder obtained by coarse grinding was set into the electric furnace again and heat-treated at 270° C. for 3 hours in the air atmosphere to thereby obtain a composite magnetic material 10.

### Structural Analysis of Composite Magnetic Material

The crystal structure of the obtained composite magnetic material 10 was evaluated by XRD, and as a result, the diffraction peaks of ε-Fe₂O₃ and magnetite (Fe₃O₄) were confirmed, but diffraction peaks derived from other crystal structures were not confirmed.

As a result of observing a section of the particulate composite magnetic material 10 by using a TEM, a sea-island structure in which a plurality of islands formed of ε-Fe₂O₃ were present in a sea (a continuous phase) formed of Fe₃O₄ was confirmed.

### Evaluation of Magnetic Properties of Composite Magnetic Material

The temporal stability of the magnetic properties of composite magnetic material 10 was evaluated in the same manner as in Example 1. Table 1 shows the results.

TABLE 1

| | | | | | | | Magnetic properties | |
|---|---|---|---|---|---|---|---|---|
| | Magnetic material features | | | | | | Residual | |
| | | | Soft magnetic phase | | | | magnetic | Coercive |
| | | Hard | | | Treatment | | flux density | force |
| | | magnetic | | Treatment | temperature | | retention | retention |
| | | phase | | atmosphere | (° C.) | Structure | ratio (%) | ratio (%) |
| Example 1 | Composite magnetic | ε-Fe₂O₃ | Fe₃O₄ | H₂(2%) + N₂(98%) | 350 | sea-island | 99.6 | 99.5 |
| | material 1 | | | | | | | |
| Example 2 | Composite magnetic | ε-Fe₂O₃ | Fe₃O₄ | H₂(2%) + N₂(98%) | 380 | core-shell | 99.4 | 99.8 |
| | material 2 | | | | | | | |
| Example 3 | Composite magnetic | ε-Fe₂O₃ | Fe₃O₄ | H₂ | 350 | sea-island | 99.7 | 99.6 |
| | material 3 | | | | | | | |
| Example 4 | Composite magnetic | ε-Fe₂O₃ | Fe₃O₄ | H₂ | 370 | sea-island | 99.5 | 99.7 |
| | material 4 | | | | | | | |
| Example 5 | Composite magnetic | ε-Fe₂O₃ | γ-Fe₂O₃ | Air | 350 | sea-island | 99.9 | 99.7 |
| | material 5 | | | | | | | |
| Comparative | Composite magnetic | ε-Fe₂O₃ | α-Fe | H₂(2%) + N₂(98%) | 500 | sea-island | 81.3 | 79.4 |
| Example 1 | material 6 | | | | | | | |
| Comparative | Composite magnetic | ε-Fe₂O₃ | α-Fe | H₂(2%) + N₂(98%) | 500 | core-shell | 80.8 | 80.1 |
| Example 2 | material 7 | | | | | | | |
| Example 6 | Composite magnetic | ε-Fe₂O₃ | Fe₃O₄ | H₂(2%) + N₂(98%) | 350 | sea-island | 99.6 | 99.8 |
| | material 8 | | | | | | | |
| Example 7 | Composite magnetic | ε-Fe₂O₃ | Fe₃O₄ | N₂ | 410 | sea-island | 99.8 | 99.6 |
| | material 9 | | | | | | | |
| Example 8 | Composite magnetic | ε-Fe₂O₃ | Fe₃O₄ | N₂ | 400 | sea-island | 99.9 | 99.8 |
| | material 10 | | | | | | | |

As shown in Table 1, each composite magnetic material in Examples 1 to 5 has high retention ratios of residual magnetic flux density and coercive force of 99% or more and therefore has high temporal stability. On the other hand, each composite magnetic material of Comparative Examples 1 and 2 has low retention ratios of residual magnetic flux density and coercive force of around 80% and therefore has low temporal stability.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-079190 filed Apr. 12, 2017 and No. 2018-023553 filed Feb. 13, 2018, which are hereby incorporated by reference herein in their entirety.

What is claimed is:

1. A composite magnetic material comprising a soft magnetic material and a hard magnetic material, wherein the soft magnetic material and the hard magnetic material each contain elemental iron, 90 atom % or more and 100 atom % or less of the elemental iron contained in the soft magnetic material forms a first oxide or a first composite oxide, and 90 atom % or more and 100 atom % or less of the elemental iron contained in the hard magnetic material forms a second oxide or a second composite oxide.

2. The composite magnetic material according to claim 1, wherein the second oxide or the second composite oxide contains ε-Fe₂O₃ or a composite oxide in which Fe in ε-Fe₂O₃ is partly substituted by at least one member selected from the group consisting of Ga, Al, Ni, and Co.

3. The composite magnetic material according to claim 2, wherein the first oxide or the first composite oxide contains Fe₃O₄ or a composite oxide in which Fe in Fe₃O₄ is partly substituted by at least one member selected from the group consisting of Ga, Al, Ni, and Co.

4. The composite magnetic material according to claim 3, wherein the soft magnetic material and the hard magnetic material are magnetically coupled to each other.

5. The composite magnetic material according to claim 2, wherein the first oxide or the first composite oxide contains γ-Fe₂O₃ or a composite oxide in which Fe in γ-Fe₂O₃ is partly substituted by at least one member selected from the group consisting of Ga, Al, Ni, and Co.

6. The composite magnetic material according to claim 5, wherein the soft magnetic material and the hard magnetic material are magnetically coupled to each other.

7. The composite magnetic material according to claim 1 comprising a sea-island structure that includes a sea portion including the soft magnetic material and an island portion including the hard magnetic material.

8. The composite magnetic material according to claim 1 comprising a core portion including the hard magnetic material and a shell portion that includes the soft magnetic material and covers at least a part of the core portion.

9. The composite magnetic material according to claim 1, wherein the soft magnetic material and the hard magnetic material are magnetically coupled to each other.

10. The composite magnetic material according to claim 1, having an elemental Nd content of 3 mass % or less.

11. A motor comprising a magnet, wherein the magnet includes a composite magnetic material comprising a soft magnetic material and a hard magnetic material, wherein
the soft magnetic material and the hard magnetic material each contain elemental iron,
90 atom % or more and 100 atom % or less of the elemental iron contained in the soft magnetic material forms a first oxide or a first composite oxide, and
90 atom % or more and 100 atom % or less of the elemental iron contained in the hard magnetic material forms a second oxide or a second composite oxide.
